(19) United States
(12) Patent Application Publication
(10) Pub. No.: US 2014/0326803 A1
(43) Pub. Date: Nov. 6, 2014

(54) WATER GUN CLEARING APPARATUS AND METHOD

(71) Applicant: Jinjing QUI, Windsor (CA)

(72) Inventor: Jinjing QUI, Windsor (CA)

(21) Appl. No.: 13/887,164

(22) Filed: May 3, 2013

(51) Int. Cl. B60S 3/04; B05B 15/02

(52) U.S. Cl. CPC B60S 3/047; B05B 15/025
USPC 239/112

(57) ABSTRACT

A water gun clearing apparatus, particularly for application in self-serve car wash units, for use in clearing standing water from hoses, pipes and the water gun as well as preventing residual water moisture from building-up within the water gun. The water gun clearing apparatus comprises an air regulation system connectable to a source of pressurized air, and a timer. The air regulation system comprises a first air line branch configured to provide a continuous supply of pressurized air at a first flow rate, and a second air line branch configured to provide a supply of pressurized air at a second flow rate. Following use of the water gun by a user, the timer activates and provides pressurized air to the water gun at the second flow rate for a pre-determined time period in order to clear residual water from the water line and water gun.

### FIELD OF THE INVENTION

The invention relates to water gun clearing apparatus for clearing residual water from a water gun and water gun components and in particular to a gun clearing apparatus comprising a first air line branch configured to a provide a continuous supply of pressurized air at a first flow rate to prevent water moisture accumulation, and a second air line branch comprising a gun clearing valve configured to provide a supply of pressurized air at a second flow rate in order to clear residual water from the water gun.

### BACKGROUND

The removal of water from water supply pipes, hoses and other forms of water delivery mechanisms is of the utmost importance, given that in winter months when temperatures drop below freezing trapped water can freeze, expand and cause rupture or other forms of damage. In apparatuses containing many small, intricate components, even the slightest moisture build-up within such components can cause significant damage upon freezing and expansion, given the small tolerance and clearance between components.

Various methods and mechanisms known in the art address the problem of residual water build up through the use of periodic blasts of compressed air to blow residual water out from hoses, pipes and similar apparatuses. While these methods and mechanisms can be effective in removing standing pools of water, they still allow water moisture to build-up within small clearances and components between compressed air blasts.

This is particularly problematic in applications such as self-service car wash units, where water guns used for car cleaning are constantly exposed to outdoor sub-freezing temperatures during winter months. Water guns contain many small components and very small clearances, especially in the nozzle portion of the gun. The slightest moisture accumulation during winter months can cause the nozzle portion of a water gun to become blocked by ice expansion, or in worst case scenario cause significant damage to the water gun nozzle.

There is therefore a need in the art for an improved water gun clearing apparatus, particularly for clearing standing water from hoses, pipes and the water gun as well as preventing residual water moisture from accumulating within the water gun.

### SUMMARY OF THE INVENTION

According to the present invention, there is provided a water gun clearing apparatus comprising a water gun connected to both a water line and an air regulation system. The water line is connected to a water source and the air regulation system is connectable to a source of pressurized air. The air regulation system comprises a first air line branch configured to provide a continuous supply of the pressurized air at a first flow rate and a second air line branch comprising a gun clearing valve configured to provide a supply of the pressurized air at a second flow rate. A one-way check valve is connected to the water line and is configured to prevent back flow of water from the water line into at least the first air line branch when the water gun is in use. The apparatus further comprises a timer activatable to provide a supply of the pressurized air to the water gun at the second flow rate for a pre-determined time period following use of the water gun in order to clear residual water from the water gun.

In one embodiment, the gun clearing valve is configured to open when the timer is activated. Air is then permitted to flow through both the first and second air line branches.

In one embodiment, the first air line branch comprises an air flow regulator. In an alternative embodiment, the first and second air line branches may be connected in parallel between the sources of pressurized air and the water gun. When the timer is activated, the timer causes the gun clearing valve to activate, allowing pressurized air at the second flow rate to flow through the second air line branch, and when the timer is deactivated, the timer causes the gun clearing valve to deactivate, thereby preventing pressurized air from flowing through the second air line branch. When the timer is deactivated air flow is channeled entirely along the first air line branch and through the air flow regulator. The air flow regulator restricts and decreases the air flow coming from the pressurized air source to the first flow rate.

The first and second flow rates may be optimized such that air is supplied at the second flow rate to clear residual water from within the water gun and a continuous stream of pressurized air is supplied at the first flow rate to prevent water moisture from accumulating in the water gun. In one embodiment, the flow ratio between the first and second flow rates is from 1:100 to 1:4000.

In an alternative embodiment, the timer may be configured to activate automatically following use of the water gun. Additionally, the water gun clearing apparatus may comprise a water gun operational switch configured to activate the water gun and a relay sensor operatively connected to the water gun operational switch and the timer, wherein the relay sensor is configured to cause activation of the timer upon deactivation of the water gun operational switch.

Additionally, there is herein provided a method of clearing water from a water gun using the water gun clearing apparatus described above. An air line supplying compressed air to a water line is connected to a water source through a one-way check valve, the one-way check valve preventing back flow of water from the water line into the air line. A continuous stream of pressurized air is supplied to the water line at a first flow rate to prevent water moisture from accumulating in the water line, and a periodic supply of pressurized air is supplied at a second flow rate, for a preset time period, to clear residual water from the water gun. In one embodiment, the flow ratio between the first and second flow rates is from 1:100 to 1:4000.

### BRIEF DESCRIPTION OF THE DRAWINGS

Having summarized the invention, embodiments thereof will now be described with reference to the accompanying figures, in which:

FIG. 1 shows a schematic representation of an embodiment of a water gun clearing apparatus installed in a car wash;

FIG. 2 shows an enlarged portion of the schematic representation of FIG. 1;

FIG. 3 shows a schematic representation of the embodiment of the apparatus of FIG. 1 in a first flow configuration;

FIG. 4 shows a schematic representation of the embodiment of the apparatus of FIG. 1 in a second flow configuration;

FIG. 5 shows a schematic representation of the embodiment of the apparatus of FIG. 1 in a third flow configuration; and,

FIG. 6 shows a schematic representation of the embodiment of the apparatus of FIG. 1 in a fourth flow configuration.

### DETAILED DESCRIPTION

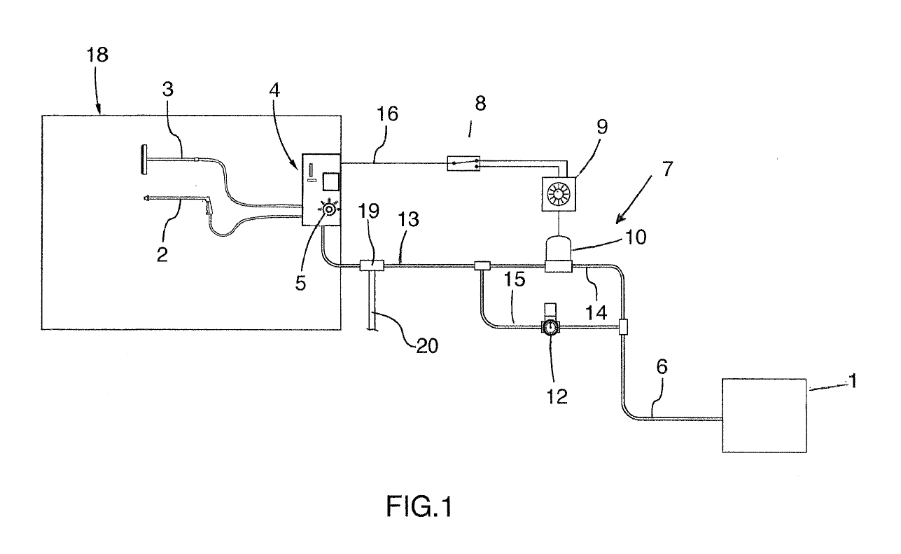

FIG. 1 shows a general schematic illustrating the components of an embodiment of a water gun clearing apparatus implemented within a car wash bay to prevent moisture build-up and corresponding water damage to a pressurized water gun. FIG. 1 depicts a manual car wash bay 18 containing a pressurized water gun 2 and soap brush 3. A user controls operation of the water gun 2 and soap brush 3 through the use of a coin operated user interface 4 containing a water gun operational switch 5. A user places a coin into the interface 4 and through the operational switch 5 is able to select between usage of the water gun 2 or the soap brush 3 during a pre-paid time period.

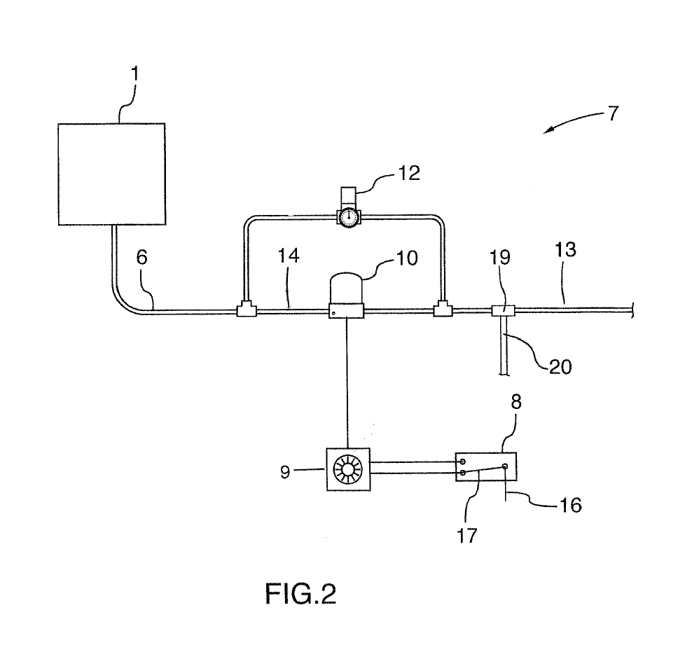

FIG. 1 depicts an air regulation system 7 interposed between a source of pressurized air 1 for the car wash facility and the car wash bay 18. The air supply 7 is used to provide pressure to the water for use in the spray function of the water gun 2, as well as to clear residual water from the gun in accordance with the invention. A first air line 6 supplies pressurized air from a source of pressurized air 1 to the air regulation system 7, and a second air line 13 supplies pressurized air from the air regulation system 7 to the water gun 2 (and possibly soap brush 3, as discussed below). FIG. 2 illustrates the components of the air regulation system 7, which is comprised of a second air line branch 14 having a gun clearing valve 10 and a first air line branch 15 having an air flow regulator 12, each of the gun clearing valve 10 and the air flow regulator 12 disposed upon each respective branch. The first and second air line branches 15, 14 are connected in parallel, stemming from the first air line connection 6 coming from the source of pressurized air 1, and then reconnecting at the second air line connection 13 to supply pressurized air to the water gun 2. The second air line connection 13 is connected to the water line 20 supplying the water gun 2 through a tee comprising a one-way check valve 19 that allows passage of pressurized air into the water line 20, but prevents the back flow of water into the air line.

A sensor 8 is operably connected to the timer 9, which timer 9 is operably connected to the gun clearing valve 10. The sensor 8 may utilize any suitable method to determine the activation status of the water gun 2. For example, the sensor 8 may comprise a relay that is connected to the operational switch 5 through a connection 16, that provides current to the relay upon activation of the operational switch 5. The relay of the sensor 8 energizes or de-energizes according to the state of the operational switch 5 to activate, deactivate and/or reset the timer 9 in a manner as will be further described below.

Upon activation of the car wash operational switch 5 (i.e. a user inserts a coin into the user interface 4), the sensor 8 senses current passing through the operational switch 5, activating the relay and signaling the timer 9 to reset. When the operational switch 5 deactivates (i.e. the user's wash time runs out), the relay of sensor 8 reacts to a lack of current passing through the operational switch 5, and accordingly, causes the timer 9 to activate for a preset time period.

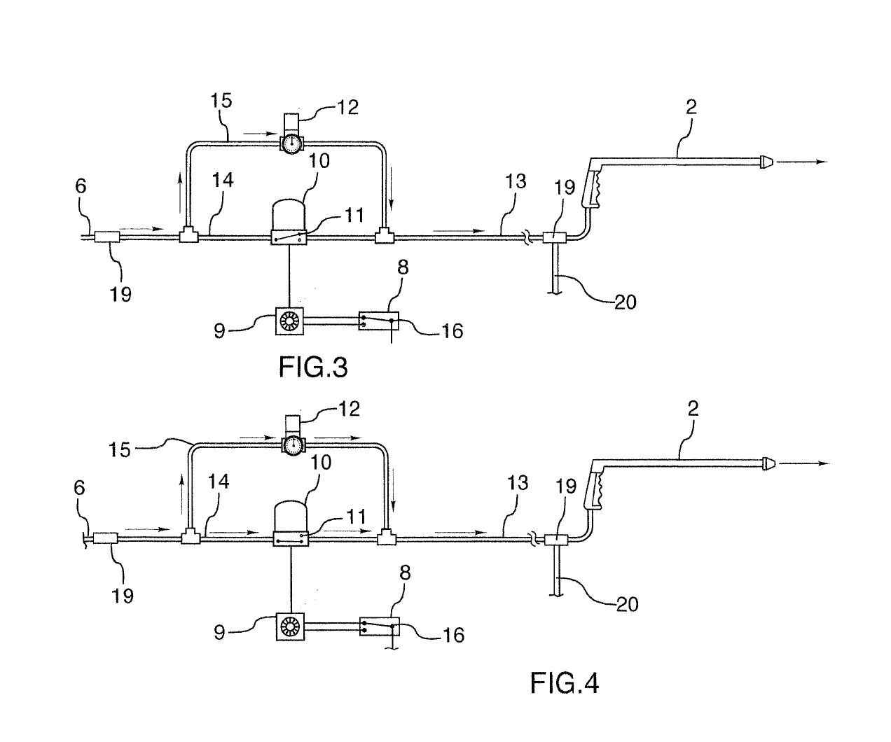

FIGS. 3 and 4 illustrate operation of air regulation system 7 prior to and during the preset time period. Prior to activation of the timer 9 during the preset time period, the gun clearing valve 10 is closed. As depicted in FIG. 3, a gun clearing valve switch 11 internal to the gun clearing valve 10 remains in closed position, thereby causing air flow from the first air line connection 6 to be channeled entirely along the first air line branch 15, through the air flow regulator 12 and out through second air line connection 13 to the water gun 2. The second air line connection 13 and water line 20 connect at the one-way check valve 19, thereby permitting air to pass out through the water gun 2, as well as into the water line 20 (as discussed below), but prohibiting water from the water line 20 from back flowing into the air line. As referenced in FIG. 4, upon activation of the timer 9 during the preset time period, the timer 9 signals the internal gun clearing valve switch 11 to move into an open position, thereby permitting pressurized air to flow from the first air line connection 6 through both the second 14 and first 15 air line branches and out through the second air line 13 to the water gun 2. In this embodiment, valve switch 11 is comprised of a solenoid valve and coil, which valve opens and closes as the coil and solenoid valve contacts are energized. The timer 9 is activated, it energizes the coil thereby opening the solenoid valve contacts comprising valve switch 11.

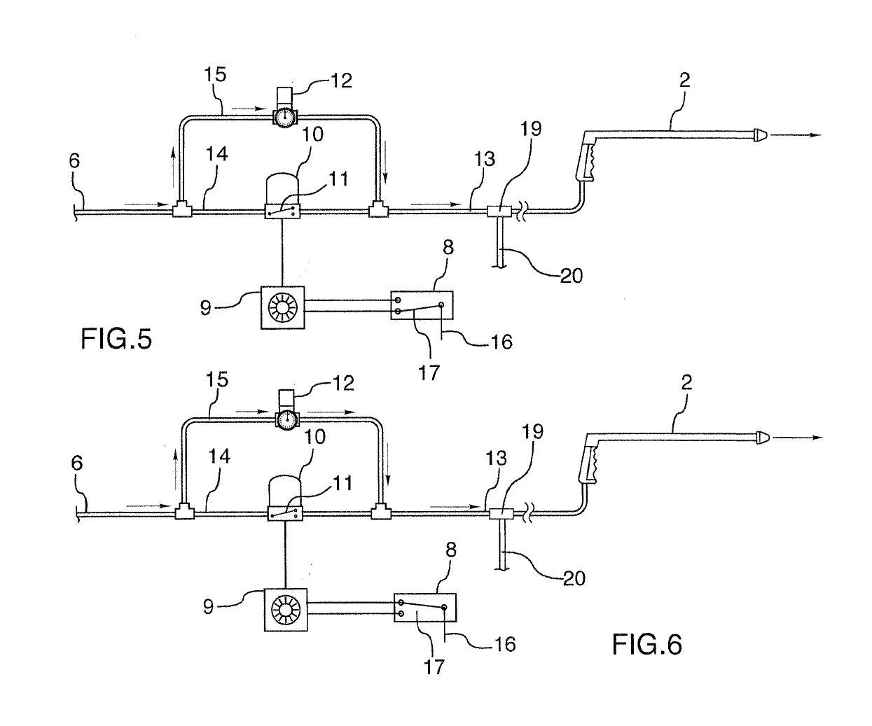

FIG. 5 illustrates operation of the air regulation system 7 following expiration of the preset time period. Upon deactivation of the timer 9 following expiration of the preset time period, the internal gun clearing valve switch 11 of the gun clearing valve 10 returns to the closed position. Again, once the gun clearing valve switch 11 returns to the closed position, air flow from the first air line connection 6 is again channeled entirely along the first air line branch 15, through the air flow regulator 12 and out through second air line connection 13 to the water gun 2 at the first flow rate.

During activation of timer 9 during the preset time period, the gun clearing valve 10 is opened, allowing full pressure pressurized air at a second flow rate to flow from the source of pressurized air 1 through the gun clearing valve 10 to the water gun 2. As seen in FIG. 4, during the preset time period of activation of the timer 9, pressurized air flowing from the source of pressurized air 1 via the first air line connection 6 passes through both of the first 15 and second 14 air line branches through to the second air line connection 13. As the first 15 and second 14 air line branches are in parallel, the air pressure of passing through the second air line connection 13 to the water gun 2 is approximately equivalent to the air pressure coming from the source of pressurized air 1 along the first air line connection 6. Similarly, all air flow passes through the air gun 2 at the second flow rate.

Deactivation of the operational switch 5 indicates that the user has completed their use of the water gun 2, and as such, activation of the timer 9 and corresponding opening of the gun clearing valve 10 during the preset time period permits full, high pressure and high flow rate air, at the second flow rate, from the source of pressurized air 1 to pass through the air regulation system 7 to the water gun 2. This preset time period is a ‘blow out’ period, whereby full, high flow rate air passes through the first 6 and second 13 air line connections, as well as the water gun 2 to clear residual water out from the water lines and the water gun 2.

Once the timer 9 deactivates following completion preset time period, the timer 9 signals the gun clearing valve 10 to close, thereby channeling all air from the pressurized air source 1 through the first air line branch 15 and through the air flow regulator 12. The air flow regulator restricts and decreases the air flow coming from the pressurized air source 1 to the first flow rate. Therefore, at all times when the timer 9 is inactive, a continuous flow of low pressure air at the first flow rate passes from the first air line branch 15, through to the second air line connection 13 and through the water gun 2. This continuous stream of low flow air prevents the build up of water moisture from accumulating within the water lines, at the tip and within the components of the water gun 2.

FIGS. 5 and 6 further illustrate the operation and relationship between the relay sensor 8 and the timer 9. The relay sensor 8 contains an internal switch 17, which signals activation/deactivation of the timer 9. As seen in FIG. 5, during the period following expiration of the preset time period, the internal switch 17 of the relay sensor 8 remains in a first position. As seen in FIG. 6, upon activation of operational switch 5 (i.e. a user inserts a coin into the user interface 4), current passing through the operational switch 5 causes the internal switch 17 to move to a second position. When switched to the second position, the internal switch 17 signals the timer 9 to reset to the preset time period, through the use of a relay/switching mechanism internal to the timer 9. Finally, once the operational switch 5 again deactivates, and accordingly, current no longer passes through the operational switch 5, this lack of current causes the internal switch 17 to return to first position, thereby signaling the timer 9 to activate and operate for the duration of the preset time period, and causing the air blowout cycle to repeat.

One skilled in the art would appreciate that any standard relay switch would be suitable for the operations described above, such as those manufactured by Schneider Electric® which are utilized in the preferred embodiment. Furthermore, any variety of timers may selected. In the preferred embodiment, a CHiNT® timer capable of connection to a standard AC electrical outlet is utilized. The required technical specifications of the selected relay sensor 8 would depend on the current/voltage requirements of the particular operational switch 5 and the timer 9 used. Selection and configuration of the relay sensor 8 as well as the timer 9 are well within the purview of one skilled in the art.

FIGS. 3-6 illustrate the repeating blowout cycle, whereby the relay sensor 8 senses current through the operational switch 5, and based on this current signal, sets and/or activates the timer 9, which in turns activates the gun clearing valve 10. When the preset time period of the timer 9 expires, and the timer 9 deactivates, the gun clearing valve 10 closes and all pressurized air from the source 1 is channeled through air flow regulator 12 and air pressure flow rate is reduced to the first flow rate, with the air at the first flow rate being channeled to the water gun 2. This cycle continuously repeats with activation and deactivation of the operational switch 5. Following use of the water gun 2, the blow out cycle begins with air at the second flow rate being channeled through the air line connection 13 to remove residual water from the line 13, and through the one-way check valve 19 and out to the water gun 2 in order to blow out residual water in the water line 20 as well as the water gun 2. Following completion of the blow out cycle (i.e. following expiration of the preset time period), the continuous low flow stream of air flowing at the first flow rate through the air lines and water gun 2 ensures that water residue does not accumulate at the tip of the water gun 2 and within the water gun 2 components.

In the preferred embodiment, the full air pressure of air flow from the source 1 can be anywhere within the range of 50-200 psi, which is the corresponding air pressure during the blow out cycle. The preset time period for the blow out cycle can range from thirty (30) seconds to six (6) minutes, depending on the total length of the first and second air line connections 6, 13. Furthermore, in the preferred embodiment, the air flow regulator 12 reduces the full air pressure to 0.1 psi for the continuous, low pressure stream of air passing through the water gun 2. Therefore, in the preferred embodiment, the flow ratio between the first and second flow rate can range from 1:100 to 1:4000. However, one skilled in the art will appreciate that the pressure values during the blow out cycle and for the continuous, low pressure stream, as well as the time duration of the preset time period, can all be readily and easily varied depending on the particular specifications of the system in use, such as the length first and second air line connections 6, 13, the characteristics of the hose used for the air and water line connections, the characteristics of the water gun 2 and the outdoor temperature in the car wash bay 18.

In practical implementation, as many air regulation systems 7 can be implemented as there are car wash bays 18 within a particular car wash facility. Each air regulation system can 7 can be interposed upon each individual first 6 and second 13 air line connections carrying pressurized air from the source 1 to the water gun 2 in each individual water gun 2 in each bay 18, by connecting the second air line connection 13 to the water line for each individual bay 18. Furthermore, two separate relay/timer configurations, and any number of relay configurations can be connected as required.

Additional variants, equivalents, embodiments and features of the invention can be conceived by persons of skill in the art and are intended by the inventor to be encompassed by the following claims. The invention is defined only as set out in the claims hereof and such claims are intended to be construed broadly within the meaning supported by the specification.

1. A water gun clearing apparatus comprising:
a water line connectable to a water source;
an air regulation system connectable to a source of pressurized air, the air regulation system comprising a first air line branch configured to provide a continuous supply of the pressurized air at a first flow rate and a second air line branch comprising a gun clearing valve configured to provide a supply of the pressurized air at a second flow rate;
a water gun connected to both the air regulation system and the water line;
a one-way check valve configured to prevent back flow of water from the water line into at least the first air line branch when the water gun is in use; and,
a timer activatable to provide a supply of the pressurized air to the water gun at the second flow rate for a pre-determined time period following use of the water gun in order to clear residual water from the water gun.

2. The water gun clearing apparatus of claim 1, wherein the gun clearing valve is configured to open when the timer is activated.

3. The water gun clearing apparatus of claim 1, wherein, when the timer is activated, air is permitted to flow through both the first and second air line branches.

4. The water gun clearing apparatus of claim 1, wherein the first air line branch comprises an air flow regulator.

5. The water gun clearing apparatus of claim 1, wherein the first and second air line branches are connected in parallel between the source of pressurized air and the water gun.

6. The water gun clearing apparatus of claim 1, wherein, when the timer is activated, the timer causes the gun clearing valve to activate, allowing pressurized air at the second flow rate to flow through the second air line branch, and when the timer is deactivated, the timer causes the gun clearing valve to deactivate, thereby preventing pressurized air from flowing through the second air line branch.

7. The water gun clearing apparatus of claim 1, wherein the first and second flow rates are optimized such that air is supplied at the second flow rate to clear residual water from within the water gun and a continuous stream of pressurized air is supplied at the first flow rate to prevent water moisture from accumulating in the water gun.

8. The water gun clearing apparatus of claim 1, wherein the flow ratio between the first and second flow rates is from 1:100 to 1:4000.

9. The water gun clearing apparatus of claim 1, wherein the timer is configured to activate automatically following use of the water gun.

10. The water gun clearing apparatus of claim 1, wherein the water gun clearing apparatus further comprises a water gun operational switch configured to activate the water gun and a relay sensor operatively connected to the water gun operational switch and the timer, and wherein the relay sensor is configured to cause activation of the timer upon deactivation of the water gun operational switch.

11. A method of clearing water from a water gun comprising the steps of:
connecting an air line supplying compressed air to a water line connected to a water source through a one-way check valve, the one-way check valve preventing back flow of water from the water line into the air line; and,
supplying a continuous stream of pressurized air to the water line at a first flow rate to prevent water moisture from accumulating in the water line, and providing a periodic supply of pressurized air for a preset time period at a second flow rate to clear residual water from the water gun.

12. The method of claim 11, wherein the flow ratio between the first and second flow rates is from 1:100 to 1:4000.
